(19) United States
(12) Patent Application Publication
(10) Pub. No.: US 2008/0034932 A1
(43) Pub. Date: Feb. 14, 2008

(54) Method and Device for Calibrating Seam Cutters and Blade-Carrier Heads

(76) Inventor: Oliver Abel, Hilden (DE)

Correspondence Address: FRIEDRICH KUEFFNER, 317 MADISON AVENUE, SUITE 910, NEW YORK, NY, 10017, US

(21) Appl. No.: 11/629,507

(22) PCT Filed: Jul. 5, 2005
(86) PCT No.: PCT/EP05/07244

§ 371 Date: Dec. 13, 2006

(30) Foreign Application Priority Data
Jul. 21, 2004 (DE) 10 2004 035 417.

(51) Int. Cl. B23D 31/04; B23D 25/14

(52) U.S. Cl. 83/13; 83/830

(57) ABSTRACT

The invention relates to a method and to a device, wherein a first blade-carrier head (13) is rigidly secured in an axial direction and counter to rotation to an axially fixed blade shaft (2), a second blade-carrier head (14) is arranged on an axially displaceable, play-free blade shaft (3) which is connected to the axially fixed blade shaft (2) by a drive connection such that the blade-carrier heads (13, 14) are disposed in an aligned manner on a plane enabling the blade gap adjusting device (4) to be displaced to a zero position from the blade shaft (3) which can be axially displaced in only one direction. The second blade-carrier head (14) is adjusted by rotating on the blade shaft (3) in such a manner that both of the blade-carrier heads (13, 14) form a gap which is equal to zero and that the second blade-carrier head (14) is axially secured to the blade shaft (3), in said position, and counter to rotation.

The invention concerns a method for calibrating edge cutters and their shearing heads and a device for carrying out this method, where the edge cutter has an axially fixed cutter shaft and a cutter shaft that can be axially displaced by means of a blade gap adjuster.

In the production of metal strip in continuously operating strip plants, the edges of the strip are trimmed with shears. It is customary to coil the cut edges by means of edge coilers or to compress them by means of scrap presses. A disadvantage of these operations is that, during the changing of an edge coil or during the compressing process, the edge which follows cannot be handled or processed. Therefore, edge cutters were developed which continuously cut the edge into small pieces.

Edge cutters of this type operate as rotary shears, whose one or more pairs of blades continuously rotate and cut the edge into pieces. The blades mesh as they move past each other to make the cut. This cutting process is carried out at different blade gaps, depending on the material to be cut. The blade gap can be adjusted by a blade gap adjuster during the cutting operation. This optimizes the cutting process and minimizes blade wear.

The blade gap adjuster has a shifting unit that acts on the axially displaceable cutter shaft. Since the blades are not arranged on the respective shearing heads at right angles to the edge running direction but rather obliquely, the blade gap is adjusted by axial displacement of the shearing head.

However, it has been found that, due to the manufacturing tolerances of the edge cutters, the blades gaps are not always equal. The manufacturing tolerances must be compensated by complicated means.

Therefore, the objective of the invention is to specify a method for calibrating edge cutters and their shearing heads and to specify a device for carrying out this method, by means of which method and device the manufacturing tolerances can be compensated.

To achieve this objective, it is proposed that the first shearing head is secured on the axially fixed cutter shaft in such a way that it is fixed in the axial direction and secured against rotation; that the second shearing head is arranged on the axially displaceable cutter shaft, which is in a backlash-free driving connection with the axially fixed cutter shaft, in such a way that the shearing heads are aligned in a plane; that the blade gap adjuster is placed in a zero position, from which the axially displaceable cutter shaft can be moved in only one direction; that the second shearing head is adjusted in such a way by rotation on the cutter shaft that the blades of the two shearing heads form a gap equal to “zero”; and that the second shearing head is secured in this position on the cutter shaft both axially and against rotation.

On the one hand, as a result of the fact that in the zero position of the axially displaceable cutter shaft, the shearing heads are aligned with each other in such a way that they are flush at a zero blade gap, the edge cutter is calibrated. On the other hand, however, the blade on the edge cutter is also calibrated, so that even after removal and possibly resharpening of the blade, readjustment is not necessary.

It is advantageous if the axial position of the blade drums on the cutter shafts is secured by pinning and/or bolting stop rings on the respective cutter shafts. As a result of the fact that a stop ring is connected with the cutter shaft, the axial calibration is also preserved, even if the blade drums are removed from the cutter shafts.

It was found to be effective if the shearing heads are secured against rotation by pinning and/or bolting adjusting rings on the shearing heads, such that at least one driver of each adjusting ring is brought into contact with a corresponding driver engaging device on the corresponding stop ring in such a way, without backlash, that rotation of the rings relative to each other is prevented.

As a result, the rings are brought into a very specific position relative to each other. If, in this position, the adjusting ring is bolted to the shearing head, a reproducible adjustment of the shearing heads on the edge cutter is obtained.

It was found to be effective for the shearing heads to be axially secured by actuating a hydraulic coupling and/or by mounting end plates on the cutter shafts.

The shearing heads are driven by means of the stop ring that is rigidly joined with the cutter shaft and by means of the adjusting ring that is rigidly joined with the shearing head. The rings are positioned by drivers. To prevent the rings from separating from each other, it has been found to be effective to use a hydraulic coupling, which clamps the shearing head on the cutter shaft, or, to use an end plate, which presses the shearing head against the stop ring.

It is advantageous if the shearing heads provided with the fixed adjusting rings can be detached from the edge cutter and slipped onto other edge cutters to calibrate such edge cutters. In this case, the respective stop rings of the other edge cutters can be brought into contact with the already calibrated adjusting rings of the shearing heads and can then be fixed on the cutter shafts with the shearing heads adjusted to zero gap.

This makes it possible to calibrate several edge cutters with one set of shearing heads. If additional sets of shearing heads are then calibrated, as proposed in claim 6, the sets of shearing heads can be arbitrarily replaced on calibrated edge cutters without any need for recalibration.

The use of an adjusting frame 20 has been found to be effective for axial adjustment of the stop rings 5, 6 and thus of the shearing heads 13, 14.

The invention is explained in greater detail below with reference to the drawings.

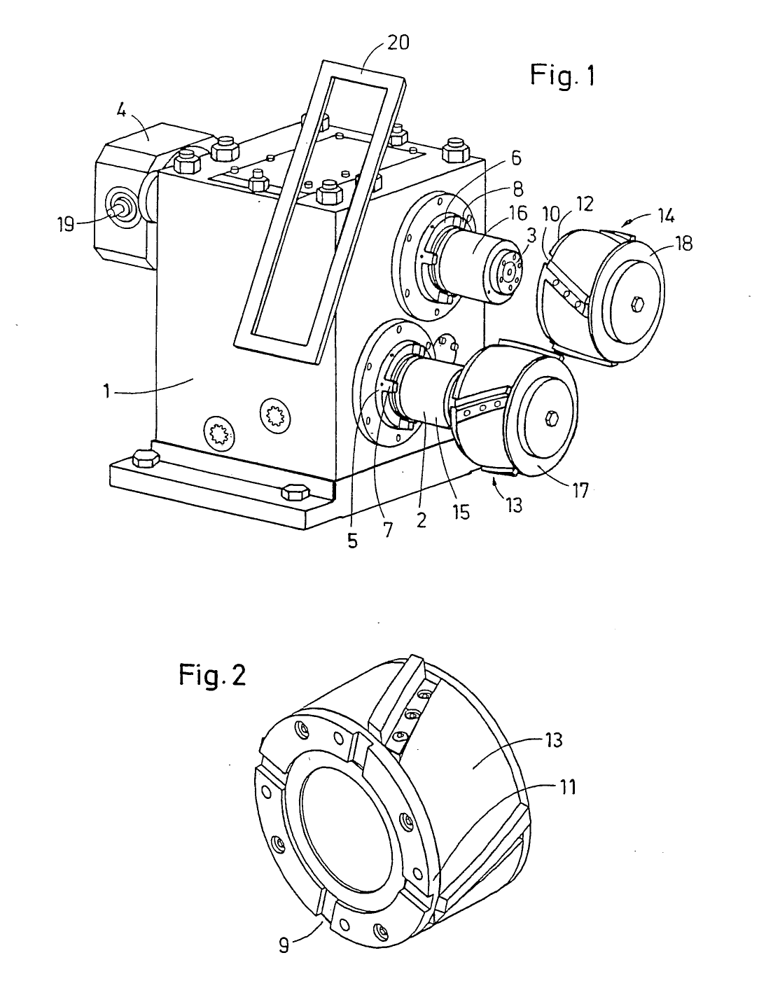

FIG. 1 shows a perspective view of an edge cutter.

FIG. 2 shows a perspective view of a shearing head.

FIG. 1 shows an edge cutter 1 with a lower, fixed cutter shaft 2 and an upper, axially displaceable cutter shaft 3. The cutter shaft 3 can be adjusted by displacing it in the axial direction by means of a blade gap adjuster 4. Stop rings 5, 6 are mounted on the cutter shafts 2, 3. The stop rings 5, 6 have drivers in the form of projections 7, 8, which are capable of engaging driver engaging devices in the form of recesses 9, 10 of adjusting rings 11, 12 of the shearing heads 13, 14. Hydraulic clamping elements 15, 16 are mounted on the cutter shafts 2, 3. The shearing heads 13, 14 can be secured on the cutter shafts 2, 3 not only by the hydraulic clamping elements 15, 16 but also by end plates 17, 18.

The calibration of the edge cutter 1 and the shearing heads 13, 14 is carried out in the following way:

The stop ring 5 is fixed on the fixed lower cutter shaft 2. The adjusting ring 11 is mounted on the shearing head 13, and the shearing head 13 is pushed onto the cutter shaft and fixed there by means of the clamping element 15 and/or the end plate 17.

The blade gap adjuster 14 is adjusted to “zero” with its adjusting element 19. The cutter shaft 3 can now be moved in only one direction by means of the adjusting element 19 to open the blade gap. The stop ring 6 and the adjusting ring 12 and shearing head 13 are now pushed onto the upper cutter shaft 3. An adjusting frame (20) is used to align the loose shearing head 15 flush with the fixed shearing head 13. The stop ring 6 is then brought into operative connection with the adjusting ring 12 and moved against the shearing head 14. In this position, the stop ring 6 is rigidly connected with the cutter shaft 3. The shearing head 14 is then turned until the blades of the shearing head 13 and the blades of the shearing head 14 have formed a “zero” gap. In this position, the adjusting ring 12 is rigidly connected with the shearing head 14.

The shearing heads 13, 14 can then be removed from the edge cutter 1 and placed on another edge cutter, on which a calibration is then carried out as described above for edge cutter 1. The only difference is that the adjusting ring 12 is already fixed, so that after the shearing heads 13, 14 have been aligned, the stop ring 6 can also be fixed only in a specific engagement position with the adjusting ring 12 on the upper cutter shaft of the new edge cutter that is now being calibrated. A large number of edge cutters can thus all be calibrated in the same way.

On these edge cutters, the stop rings 5, 6 are fixed. New sets of shearing heads can now be pushed onto the already calibrated edge cutters. If the blades are set to a gap of “zero”, the respective adjusting rings 12, 13 can be fixed on the shearing heads 13, 14. The newly adjusted shearing heads thus fit all edge cutters that have already been calibrated.

### LIST OF REFERENCE NUMBERS

1. edge cutter
2. cutter shaft
3. cutter shaft
4. blade gap adjuster
5. stop ring
6. stop ring
7. projection
8. projection
9. recess
10. recess
11. adjusting ring
12. adjusting ring
13. shearing head
14. shearing head
15. clamping element
16. clamping element
17. end plate
18. end plate
19. adjusting element
20. adjusting frame

1. A method for calibrating edge cutters (1) and their shearing heads (13, 14), which have blades that are arranged and the first shearing head (13) is secured on the axially fixed cutter shaft (2) in such a way that it is fixed in the axial direction and secured against rotation, wherein
the second shearing head (14) is arranged on the axially displaceable cutter shaft (3), which is in a backlash-free driving connection with the axially fixed cutter shaft (2), in such a way that the shearing heads (13, 14) are aligned in a plane;
the blade gap adjuster (4) is placed in a zero position, from which the axially displaceable cutter shaft (3) can be moved in only one direction;
the second shearing head (14) is adjusted in such a way by rotation on the cutter shaft (3) that the blades of the two shearing heads (13, 14) form a gap equal to “zero”; and
the second shearing head (14) is secured in this position on the cutter shaft (3) both axially and against rotation.

2. A method in accordance with claim 1, wherein the axial position is secured by pinning and/or bolting stop rings (5, 6) on the respective cutter shafts (2, 3).

3. A method in accordance with claim 1, wherein the shearing heads (13, 14) are secured against rotation by pinning and/or bolting adjusting rings (11, 12) on the shearing/heads (13, 14), such that at least one driver (projection 7, 8) of the adjusting ring (11, 12) is brought into contact with the driver engaging device (recess 9, 10) on the stop ring (5, 6) in a rotationally rigid way and without backlash, so that rotation of the rings relative to each other is prevented.

4. A method in accordance with claim 1, wherein the shearing heads (13, 14) are axially secured by actuating clamping elements (15, 16) and/or by mounting end plates (17, 18) on the cutter shafts (2, 3).

5. A method in accordance with claim 1, wherein the shearing heads (13, 14) provided with the fixed adjusting rings (11, 12) can be detached from the edge cutter (1) and slipped onto other edge cutters to calibrate such edge cutters, where the respective stop rings can be brought into contact with the fixed adjusting rings and can then be fixed on the cutter shaft with the blade gap equal to “zero”.

6. A method in accordance with claim 1, wherein additional shearing heads are mounted in such a way on the edge cutters (1) provided with the fixed stop rings (5, 6) that their adjusting rings come into backlash-free contact with the stop rings (5, 6) and that the adjusting rings are fixed on the respective shearing head at a blade gap equal to “zero”.

7. A device for carrying out the method for calibrating edge cutters (1) and their shearing heads (13, 14) in accordance with claim 1, wherein the edge cutter (1) has an axially fixed cutter shaft (2) and a cutter shaft (3) that can be axially displaced by means of a blade gap adjuster (4),
wherein
stop rings (5, 6), which can be locked in the axial direction and in the direction of rotation, are assigned to the cutter shafts (2, 3) and can be positioned on them;
the stop rings (5, 6) have at least one driver (projection 7, 8);
an adjusting ring (11, 12) is assigned to the end face of each shearing head (13, 14);
each adjusting ring (11, 12) can be rotated relative to the corresponding shearing head (13, 14);
each adjusting ring (11, 12) can be locked with the shearing head (13, 14) in any given position;
the adjusting ring has at least one driver engaging device (recess 9, 10) that cooperates with the drivers (projections 7, 8); and
an adjusting frame is provided for axial adjustment of the stop rings (5, 6).
